(19) United States
(12) Patent Application Publication
(10) Pub. No.: US 2016/0107584 A1
(43) Pub. Date: Apr. 21, 2016

(54) TAILGATE LINER AND GAME APPARATUS

(71) Applicant: Penda Corporation, Portage, WI (US)

(72) Inventors: Devin Coyle, Waunakee, WI (US); Anthony C. Wangelin, DeForest, WI (US)

(21) Appl. No.: 14/881,603

(22) Filed: Oct. 13, 2015

Related U.S. Application Data
(60) Provisional application No. 62/065,480, filed on Oct. 17, 2014.

(51) Int. Cl. B60R 13/01; B60R 9/06; B60N 3/10

(52) U.S. Cl. CPC B60R 13/01; B60N 3/103; B60R 9/06; B60R 2013/016

(57) ABSTRACT

A tailgate liner and game apparatus is provided. The tailgate liner and game apparatus includes a generally rectangular panel sized and integrally formed to fit on a truck tailgate surface and substantially cover and protect an underlying surface of the truck tailgate surface. The panel includes a game board integrally formed therewith. The game board has a plurality of cup holders arranged in one or more triangular formations. The game board has a flat bounce surface between a triangular formation and an end of the panel. A tailgate liner which is a rigid polymer sheet formed to a configuration corresponding to the shape of a truck tailgate and securable to the tailgate is also disclosed. The sheet is durable and protects a portion of the truck tailgate. The sheet includes an integrally formed game surface configured to receive game pieces for game play.

### CROSS-REFERENCE TO RELATED APPLICATIONS

This application claims priority to United States Provisional patent application. Ser. No. 62/065,480, filed Oct. 17, 2014, entitled “Tailgate Liner and Game Apparatus,” the entire contents of which is hereby incorporated by reference in its entirety herein.

### FIELD

The present invention relates to a tailgate liner and game apparatus for use on the tailgate of a pick-up truck and more particularly to an integrated tailgate liner and game apparatus.

### BACKGROUND

Recently, pick-up trucks have become increasingly popular as a means for general purpose transportation and entertainment, including “tailgating” at sporting and other events. Tailgating is a very popular past time. To enhance the enjoyment of an event, it has become commonplace to bring food and beverages in one's vehicle to consume once the vehicle has been parked at the group gathering. It is very common to find groups of individuals tailgating at professional sporting events, high school sporting events, county fairs, parades, concerts, and hunting expeditions. However, tailgating is generally a social activity often associated with outdoor gatherings involving friends, foods, beverages, and activities prior to or during an event. The very term “tailgating” references the tailgate of a vehicle, whereby individuals utilize the cargo capacity of the vehicle to carry supplies and set up a temporary gathering place there around for enjoyment and socializing. Individuals may congregate around the bed of a pick-up truck or sport utility vehicle to engage in outdoor activities such as barbequing and games. Games are popular during tailgates and tailgate parties. Typically, these games include passing a ball or Frisbee around, or lawn games such as bean bag toss, ladder golf, horseshoes, among others. Many of these games are preferred because of the simplicity in the game materials. However, each game requires the tailgater to bring the requisite sport or game materials, which take up valuable cargo space used for other tailgating gear, food, seating, and coolers, but also requires the tailgater to remember to bring such materials.

A popular pick-up truck accessory is the bed liner. The bed liner is a preformed plastic liner which is placed in the cargo area of the pick-up truck. The bed liner is used to prevent direct contact between the bed of the pick-up truck and chemicals, abrasives, metal cargo, and other destructive elements which tend to scratch and/or rust the surface of the pick-up truck's bed. Tailgate liners are also often used in conjunction with pick-up truck bed liners. Tailgate liners are used to prevent the tailgate of the pick-up truck from being scratched whenever rigid objects are placed upon or cargo is slid into or out of the pick-up truck. Tailgate liners are generally preformed and are made out of the same material as the pick-up truck bed liner. These liners are often designed and purchased with their functional purpose of protecting the truck in mind.

It is evident that there is a need for a simple, compact, useful, convenient, and inexpensive multi-use article which will provide an integrated gaming apparatus for a pick-up truck.

### SUMMARY

Accordingly, a tailgate liner and game apparatus is disclosed. The present invention provides an improved, integrally formed tailgate liner and game apparatus which meets the utility and social needs of pick-up truck owners and their guests. The tailgate liner and game apparatus includes a generally rectangular panel sized and integrally formed to fit on a truck tailgate surface and substantially cover and protect an entire underlying or exposed surface of the truck tailgate. The panel includes an integrally formed game board. The game board has game elements comprising at least one plurality of cup holders arranged in a triangular formation on the panel such that the triangular formation of cup holders is positioned near an end of the generally rectangular panel and points toward an opposite end of the panel. The game board also has a flat bounce surface provided between the at least one triangular formation and the opposite end of the panel.

A tailgate liner for a pick-up truck is also disclosed. The tailgate liner is a rigid polymer sheet formed to a configuration corresponding to the shape of a pick-up truck tailgate and securable to the tailgate. The rigid polymer sheet is durable and protects at least a portion of the pick-up truck tailgate. The rigid polymer sheet includes an integrally formed game surface configured to receive game pieces for game play.

In another example, the tailgate liner and game apparatus comprise a generally rectangular panel, sized and shaped to fit on a truck tailgate load surface and substantially covering and protecting the entire exposed portion of the truck tailgate load surface. The panel includes a game board integrally formed therewith. The game board integrally includes an arrangement and positioning of cup holders including up to ten circular cup holders arranged in a triangular formation on each end of the tailgate liner to form two triangular formations of cup holders, each facing the other in mirror image fashion. The triangular formations are positioned to “point” toward the center portion of the tailgate. The triangular formations of cup holders are further defined by integrally formed outer recesses or ribs. The cup holders have a generally flat planar base forming a stable surface for holding a paper or plastic cup, and all cup holder bases are formed on the same flat plane, each cup holder being of equal size and depth and spaced equidistant from adjacent cups such that rims of the cups touch each other while allowing the cups to sit flat. Each triangular formation may include an additional cup holder located outside of the triangular formation and spaced such that a cup placed therein does not touch the other cups in the triangular formation. An integrally formed flat bounce surface defined by a rectangular or square flat area is provided between the two triangular formations. One or more game ball holders may be formed by indents or recesses in the outer facing surface of the tailgate liner. A plurality of spaced apart integral ribs may extend in parallel relation perpendicular to the direction of play, providing rigidity and utility for the game board. The plurality of spaced apart ribs may be positioned in a central portion of the tailgate liner and generally extend between the two triangular patterns of cup holders and surrounds portions thereof as well as surrounding the flat planar bounce surface. One or more engagement apertures are provided in and through the tailgate liner which are arranged to enable the panel to be securely coupled to the truck tailgate surface. The engagement apertures are receptive to one or more fasteners inserted into the engagement apertures for engagement with the tailgate surface to secure the panel to the truck tailgate surface. The tailgate liner marginal dimensions and at least some of the engagement apertures may be located to coincide with or lie within the margins of the tailgate load surfaces and fastener openings in existing commercially available pick-up truck tailgate load surfaces to assist in positioning and retaining the tailgate liner over substantially the entire tailgate surface desired to be protected and enhanced by the cover.

These and other features and advantages of devices, systems, and methods according to this invention are described in, or are apparent from, the following detailed descriptions of various examples of embodiments.

### BRIEF DESCRIPTION OF DRAWINGS

Various examples of embodiments of the systems, devices, and methods according to this invention will be described in detail, with reference to the following figures, wherein:

FIG. 1 is cut-away perspective view of a conventional pick-up truck having a truck bed or cargo compartment with a bed liner, and additionally including a truck tailgate and an integrally formed tailgate liner and game apparatus, according to one or more examples of embodiments, and also illustrating various game pieces which may be advantageously used with the tailgate liner and game apparatus.

FIG. 2 is a perspective view of the upper surface of one or more examples of embodiments of the tailgate liner of FIG. 1.

FIG. 3 is a plan view of the opposite or “bottom” formed surface of the tailgate liner shown in FIG. 2.

FIG. 4 is a front elevation view of the tailgate liner shown in FIG. 2.

FIG. 5 is a perspective view of one or more alternative examples of embodiments of a tailgate liner.

FIG. 6 is perspective view of one or more examples of embodiments of a tailgate liner and game apparatus, showing the integrated tailgate liner and game apparatus of the invention, as attached to a truck tailgate and having game pieces thereon.

FIG. 7 is cut-away a perspective view showing an alternative perspective view of the tailgate, tailgate liner, and game pieces shown in FIG. 6.

FIG. 8 is a top plan view of an alternative example of embodiments of the tailgate liner, in which example engagement apertures and surrounding formed structure are illustrated by broken lines.

FIG. 9 is a plan view from the opposite side of the tailgate liner shown in FIG. 8, which is substantially a mirror or reverse view of the liner.

FIG. 10 is a perspective view of one or more alternative examples of embodiments of the tailgate liner.

FIG. 11 is a top plan view of one or more alternative examples of embodiments of the tailgate liner.

FIG. 12 is a top plan view of one or more alternative examples of embodiments of the tailgate liner.

FIG. 13 is a top plan view of one or more alternative examples of embodiments of the tailgate liner.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

Referring to the Figures, a unitary integrated tailgate liner and game apparatus for use on the tailgate of a pick-up truck is provided.

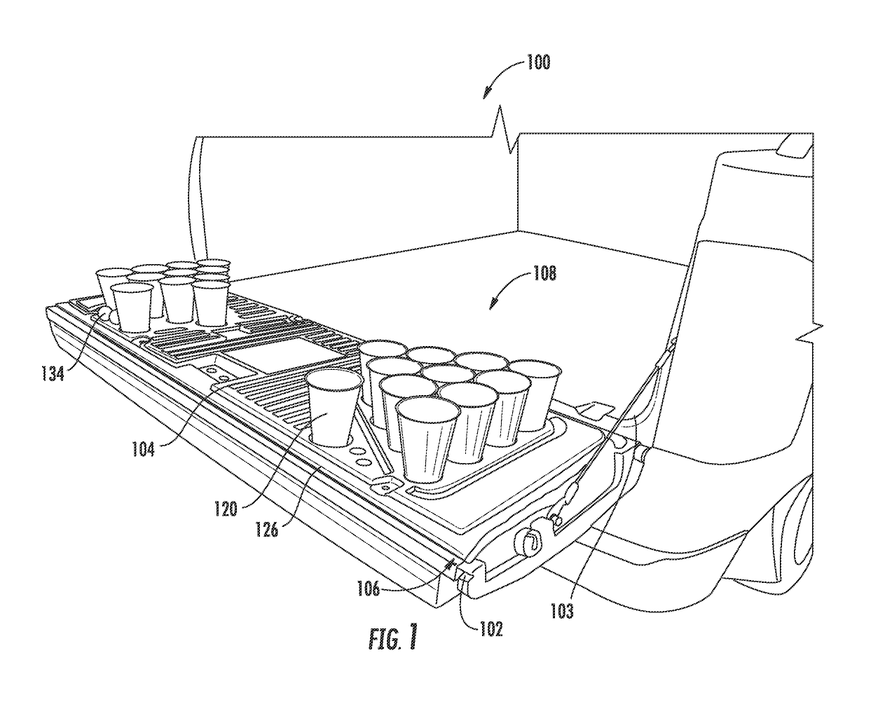

FIG. 1 illustrates a conventional pick-up truck 100 having a truck bed or cargo compartment. The truck bed includes a floor, side walls and a tailgate 102. Tailgate 102 is a conventional pick-up truck tailgate having a top portion, an outer panel and an inner panel which is a load-bearing surface when the tailgate is lowered to a horizontal position, as shown. The typical pick-up truck tailgate 102 is held in the open, horizontal, position with existing vehicle cable supports. A conventional pivot assembly provides the means to support and rotate the tailgate 102 to its vertical position where it engages existing vehicle body side tailgate latch brackets in a conventional manner when closed. A plastic truck bed liner 103 covers the floor, sidewalls, and front wall of the truck cargo bed, in a conventional manner.

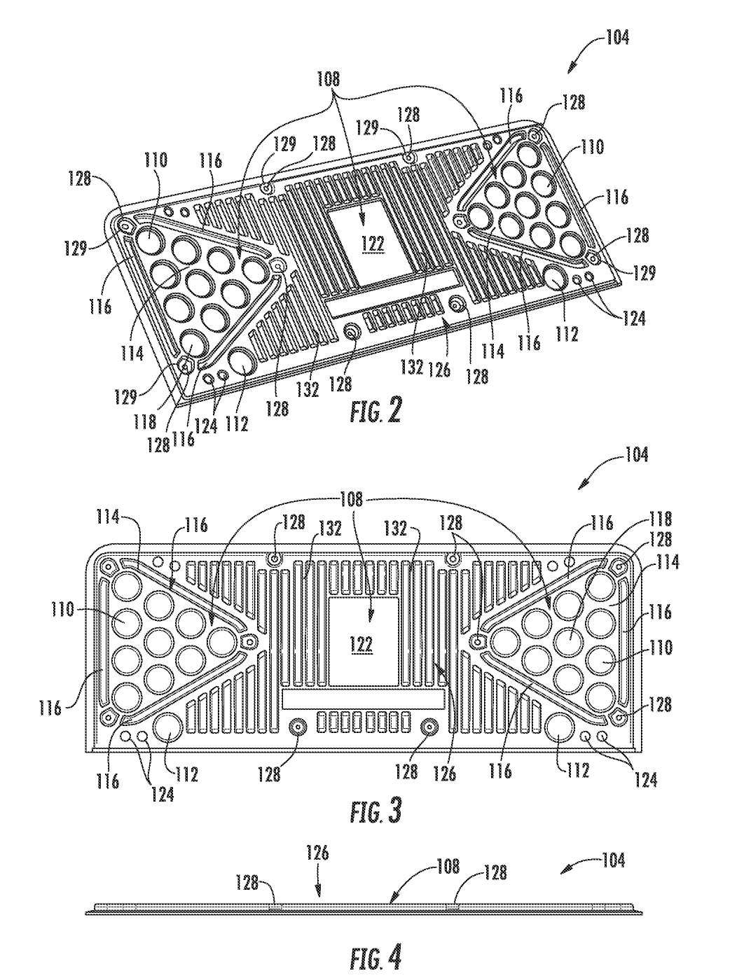

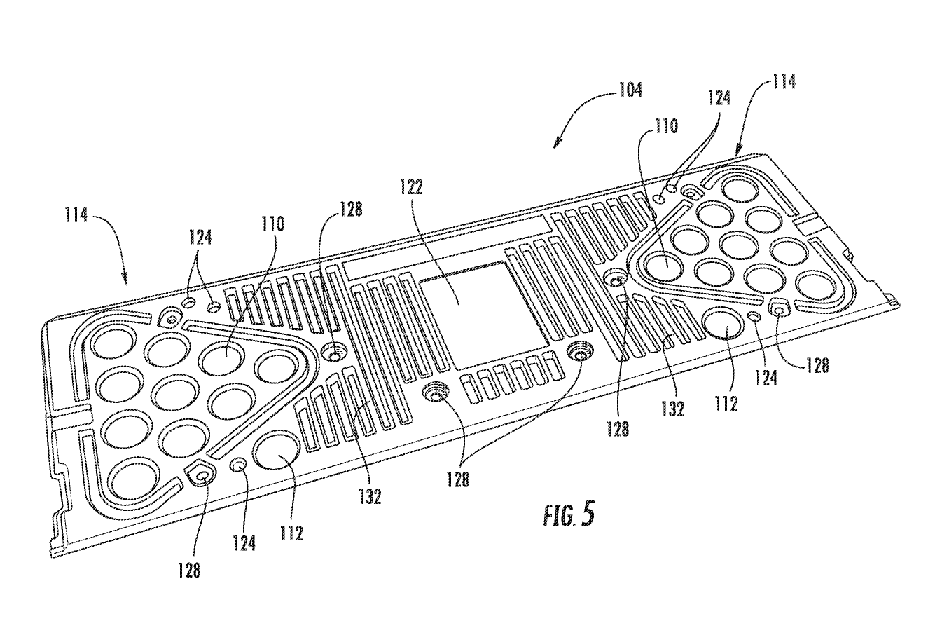

FIGS. 1-5 depict views of the tailgate liner 104 according to one or more exemplary embodiments of the present invention. For ease of reference, the improved, integrated tailgate liner 104 and game apparatus of the invention will be referred to herein as a “tailgate liner.” As can be seen in the Figure, the exemplary tailgate liner 104 is a generally rectangular plastic panel, sized and integrally formed to fit on a truck tailgate surface 106, and substantially covering the entire surface. In this regard, the tailgate liner covers and protects the underlying surface of the truck tailgate. In addition, the illustrated tailgate liner 104 includes game elements, such as a game board 108 or game playing surface integrally formed therein. Preferably, the tailgate liner 104 covers substantially all of the normally exposed upper generally horizontal surface of a tailgate 102 when the tailgate is pivoted to an open or horizontal position, as shown in FIG. 1. The game board 108 is formed at least in part by a particular arrangement and positioning of cup holders 110. That is, in the illustrated embodiment, ten (10) circular cup holders 110 are arranged in a triangular formation 114 on each end, and more specifically near each opposing end of the tailgate liner 104 to partially form a game board 108 or gaming surface within the tailgate liner 104. While ten (10) cup holders 110 are provided, more cup holders or fewer cup holders may be provided without departing from the overall scope of the present invention. Two (2) triangular formations 114 are provided, with each facing the other in a mirror image such that the triangular formations generally “point” toward the center portion of the tailgate 102 in the manner shown in FIG. 3 and each of the other figures of the drawings. Accordingly, on each side of the tailgate liner 104, cup holders 110 are arranged in a triangular pattern similar to billiard balls or bowling pins. The triangular patterns or formation 114 of cup holders 110 in one or more examples of embodiments, are further defined by outer recesses or ribs 116 which, in part, further define and rigidify the triangular game board formation. The cup holders 110 preferably each have a flat planar base 118, or generally flat planar base, to form a stable surface for holding a cup 120 (see FIG. 1). Accordingly, the bases 118 of all cup holders 110 are provided on the same flat plane in coplanar relation. The cup holders 110 may each be of equal size and depth, as shown. Each cup 120 is also preferably spaced equidistant from the adjacent cups. In one particular example, each cup holder 110 is spaced such that the rims of the cups 120 touch each other while allowing the cups to sit flat (e.g., the cup bottom remains flat against the base of the cup holder). Each triangular formation 114 preferably includes an additional cup holder 112 located just outside of the triangular formation and spaced such that a cup 120 placed therein does not touch the other cups in the formation. Preferably this additional cup holder 112 is placed to the side of the triangular formation 114, as exemplarily shown in the drawings. Additional or alternative cup holders may also be provided at a variety of non-game play locations about the tailgate liner 104. Likewise, while two triangular patterns of cup holders are illustrated and/or described, a single triangular pattern of cup holders may be used. In this regard, at least one triangular formation of cup holders is positioned near an end of the generally rectangular panel and points toward an opposite end of the panel, while the flat bounce surface is provided between the triangular formation and the opposite end of the panel.

Between the two triangular patterns or formations 114 of cup holders 110, a flat bounce surface 122 may also be provided. In the illustrated example shown in FIG. 3, the flat bounce surface 122 is defined by a rectangular or square flat area spaced equidistant between the two triangular patterns or formations 114. In one or more example, the flat bounce surface is a generally planar flat surface. In alternative examples of embodiments, the flat bounce surface 122 may be defined by a rectangular ridge or margin line, or for example by a decal or sticker similarly spaced between the triangular patterns or offset therefrom. The plane of the flat bounce surface may be coplanar with the cup bottom planar bases 118, or positioned at any level above the cup bottom bases within the upper margins of the tailgate liner 104.

In one or more exemplary embodiments, one or more game ball holders 124 may also be provided on the tailgate liner 104. The game ball holders 124 may be indents or recesses in the outer facing surface 126 of the tailgate liner 104. In the illustrated embodiment, a plurality of game ball holders 124 (e.g., two), comprising depressions for holding the game balls, are provided adjacent to the triangular formations 114.

In one or more exemplary embodiments of this invention, provisions are made or provided to secure the game board 108 to the truck tailgate 102. For example, a plurality of engagement apertures 128 may be provided in or are defined by and through the tailgate liner 104, which apertures are arranged to couple the tailgate liner 104 to the tailgate 102. The engagement apertures 128 are receptive to at least one fastener 130 for coupling the panel 104 to the truck tailgate surface, and are positioned within the panel in a manner which enables the fasteners to firmly secure the panel to the truck tailgate surface so as to resist or prevent movement of the panel and the game elements thereon with reference to a coupled tailgate surface. In the illustrated example, the tailgate liner 104 has a plurality of such apertures 128 spaced about the cover which are designed to receive a fastener 130 which is inserted into the aperture 128 and into the tailgate 102. It can be seen that the portions of the cover surrounding each aperture 128 may be recessed to provide a fastener bearing surface 129. The fastener bearing surfaces 129 may be coplanar with the cup holder bases 118 or may be positioned above the bases 118 in spaced relation to the underlying tailgate surface. In an exemplary embodiment, at least one or more of the fastener bearing surfaces 129 or recessed fastener bearing surfaces may be provided or formed in the panel without pre-drilled or pre-formed apertures 128 to permit the user to select the location of apertures by simply drilling through (or piercing or punching out) the panel at the location of bearing surface 129 or elsewhere to correspond to holes on a tailgate surface. In other words, each such fastener bearing surface 129 is adapted to facilitate a location for drilling or otherwise piercing an engagement aperture in the panel by a user of the tailgate liner, which aperture is receptive to a fastener for securing the liner to a truck tailgate.

In one or more particular embodiments, such as shown in FIGS. 3 & 5, the engagement apertures 128 are positioned to firmly secure the game elements (e.g., the triangular arrangement of cup holders, flat bounce surface, etc.) so as to resist or prevent movement. In FIG. 3, an engagement aperture 128 is positioned proximate to each of the points of the triangular formation 114, but also may be positioned along the edge of the pattern such as shown in FIG. 5. The tailgate liner 104 may also have one or more recesses or access openings for clearance of truck tailgate components (see FIG. 1).

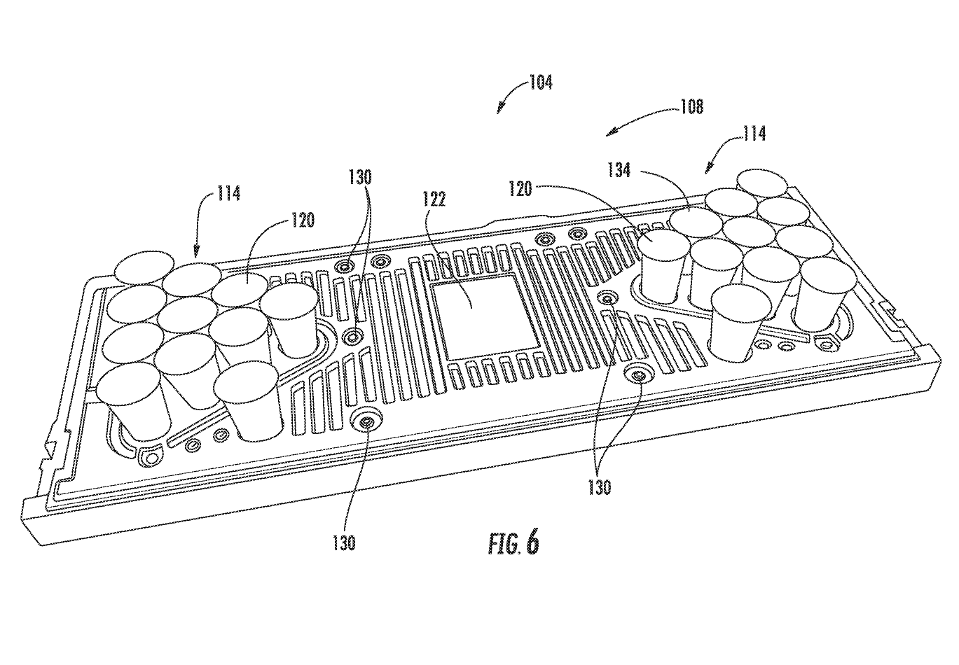

The tailgate liner 104 is securely attached to the tailgate 102 using suitable fasteners 130 (see FIGS. 6 & 7). Fasteners 130 may be used which are inserted into the engagement apertures 128 and remain flush or have a profile which does not exceed the upper surface of the tailgate liner 104. For example, conventional sheet metal screws may be acceptable. Snap fit connectors, tongue and groove, friction fit, straps and other connectors may also or alternatively be used to selectively hold or, for example removably hold, a panel 102 in position. Preferably, for the fastener 130 has a threaded insertion end which engages and secures to the truck tailgate 102, and a flat upper end connected to the insertion end by a shank or shoulder that seats against the surface of the tailgate liner 104. In one or more examples of embodiments, the fastener 130 is a screw having a spacer and a flat head. In one particular example of embodiments, the flat head and spacer are composed of a metal material treated to resist corrosion, or a polymer or plastic material. Where the truck tailgate has removable fasteners such as screws threadedly engaged in the tailgate load surface, such screws may be removed and extended through engagement apertures 128 to engage the tailgate surface and position the tailgate liner on the tailgate in register with manufacturer's locating holes. In other locations, holes may be drilled in register with the engagement apertures of the liner and fastener screws may be threaded engaged with the drilled holes to secure the liner.

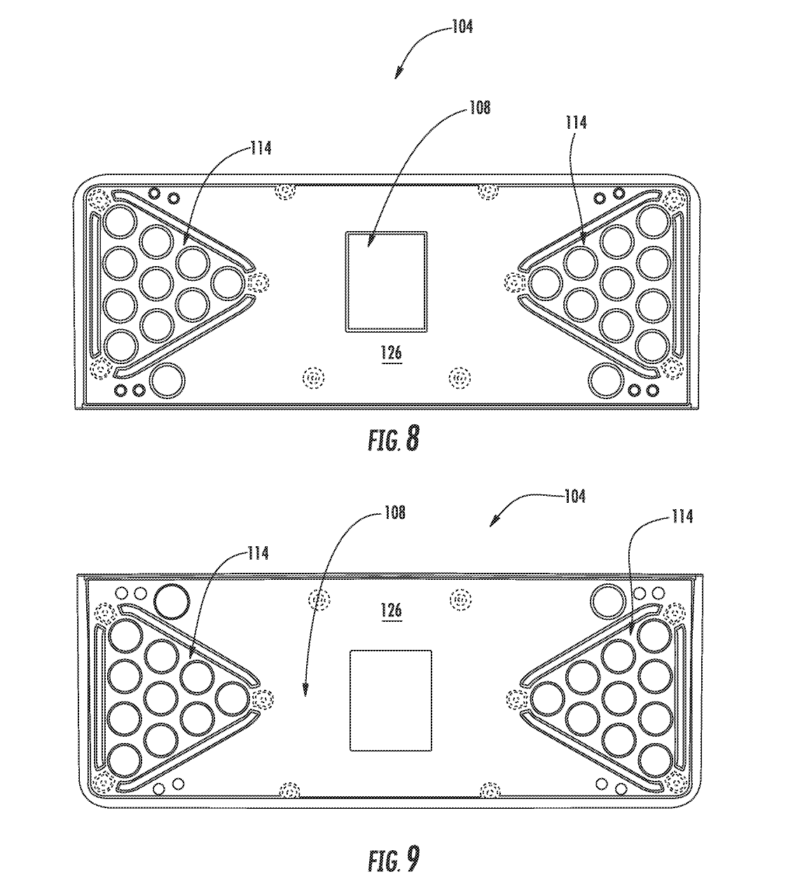

In one or more examples of embodiments, the tailgate liner 104 is provided with a plurality of spaced apart ribs 132. Ribs 132 or supplemental ribs may provide rigidity and a flat game board 108 structure. In the illustrated example of FIG. 1, the spaced apart ribs 132 extend in parallel relation perpendicular to the direction of play but are aligned with the spaced ribs of the floor of a truck bed liner positioned in the truck cargo compartment. The plurality of spaced apart ribs 132 may be positioned in a central portion of the tailgate liner 104 which generally extends between the two triangular formations 114 of cup holders 110 and may surround portions thereof, as well as surrounding the flat planar bounce surface 122. While a specific arrangement of ribs 132 and shape are provided, variations thereon accomplishing the desired purposes may be acceptable. In one or more alternative examples of embodiments, the central portion and/or the tailgate liner 104 comprises a substantially planar surface between the respective triangular formations 114 (see FIGS. 8-9). In such an example, the substantially planar surface may also serve as the flat planar bounce surface 122 for game play.

The tailgate liner 104 may be formed of the same or similar material as the bed liner of a pick-up truck. For example, the material may be formed of a durable, yet relatively thin polymer or plastic. More specifically, the tailgate liner may be formed of a lightweight yet substantially rigid material which can be extruded or molded polymer. In one example, the material is a high density polyethylene (HDPE), acrylonitrile butadiene styrene (ABS), or similar plastic. Most preferably, the cover is formed of a high molecular weight high density polyethylene (HMWHDP or HDPE) and having a formed thickness of between about 0.04 inches and about 0.18 inches. In one or more examples of embodiments, the bottom surface of the tailgate liner 104 is a substantial reverse or mirror image of the top or outer facing surface 126. In this regard, the bottom surface may closely match or correspond to the shape of a mold used to form the tailgate liner 104. In one or more examples of embodiments, the tailgate liner 104 is formed from plastic sheet material having an embossed surface. For example, the tailgate liner 104 may have a leather grain texture on at least its outer and upper facing surface 126 (i.e., the surface facing the elements and used for game play), as shown in FIG. 1.

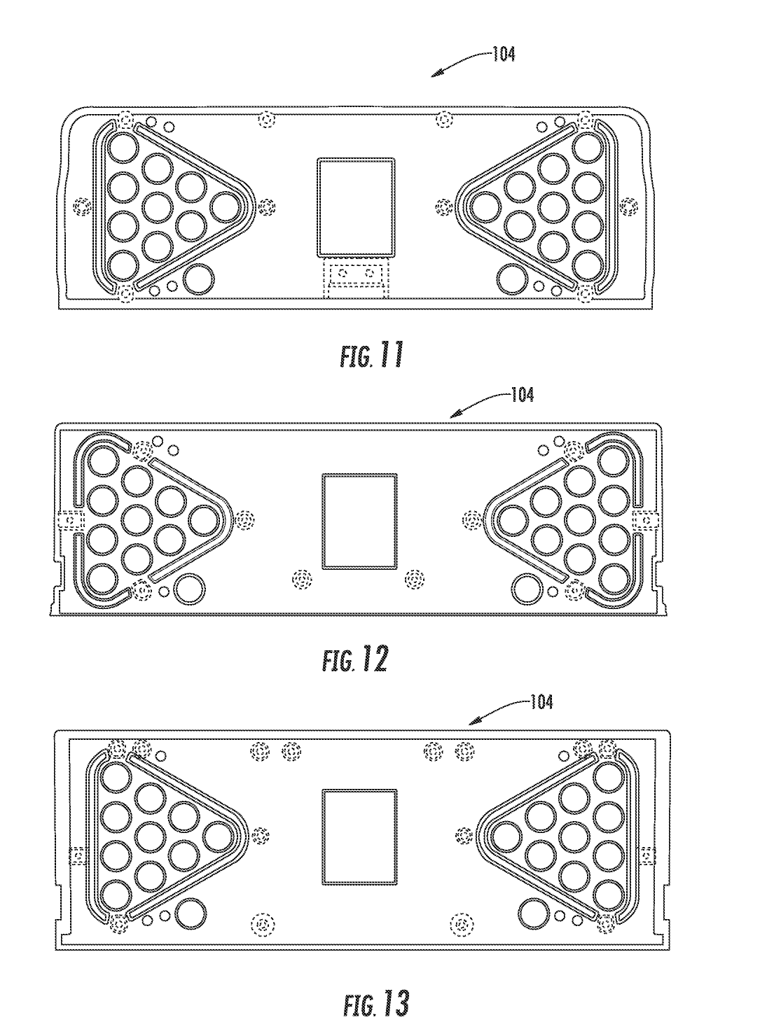

The tailgate liner 104 may be formed in any suitable configuration to adapt to the shape of a corresponding tailgate 102 on which it is placed or installed, examples of which are shown in reference to FIGS. 1 and 10-13. As can be seen by comparison of the respective Figures, variations are made in the location of the engagement apertures 128, the outer dimensions or shape, and, for example, to accommodate different types (e.g., brands) of tailgates.

During installation, the tailgate liner 104 is normally placed on the open truck tailgate 102 and one or more fasteners 130 are attached, e.g., screws extended through the liner, such as through the engagement apertures 128, and into existing holes or holes custom drilled into the tailgate 102. The tailgate liner 104 may be rested upon the tailgate 102 without fastening or attached by other means such as friction fit, tongue and groove, snap fit, various hook and loop type strap(s), and/or pads, and the like, although permanent or semi-permanent, fixed attachment provides the most benefits for its intended uses.

The tailgate 102 of the pick-up truck 100 or other utility vehicle is placed in the open configuration during a tailgating event. Namely, the tailgate 102 of the pick-up truck 100 is lowered (i.e., horizontal position), such as shown in FIG. 1, and in this position the tailgate liner game board 108 is substantially horizontally positioned such that it can be used for game play. The tailgate liner 104 in one or more examples of embodiments may be positioned on the tailgate 102 after it is in the open position, or in the preferred alternative, may be coupled to the tailgate 102 in semi-permanent attachment such that it travels with the movement of the tailgate 102 and the truck.

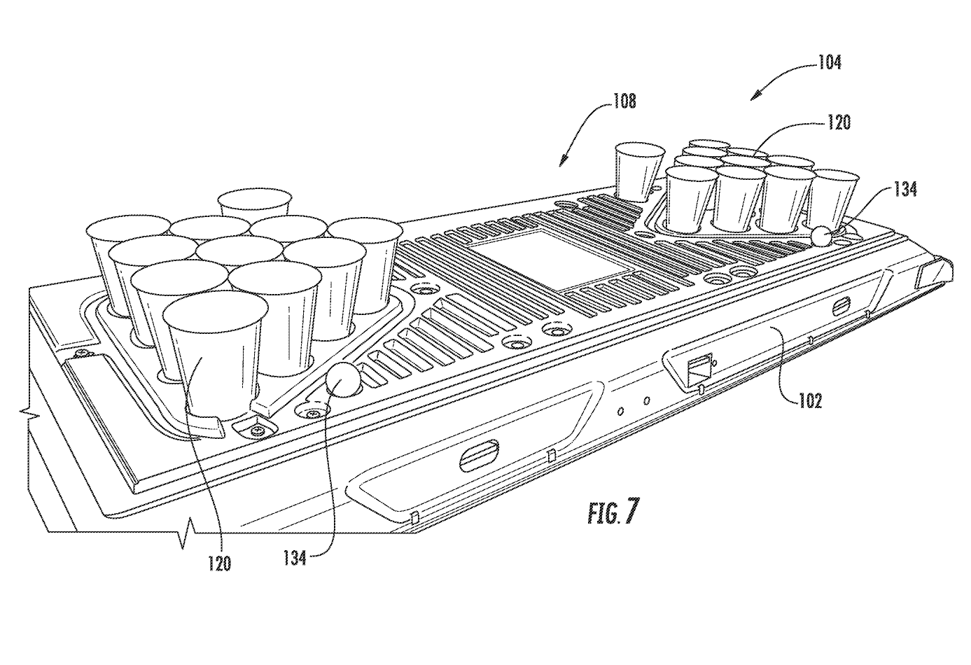

As shown in FIGS. 1, 6-7, a plurality of cups 120 may be placed in or received by the plurality of cup holders 110. These cups 120 may optionally be partially filled with a liquid, such as, for example, a beverage or water. One or more balls 134 (e.g., ping pong balls) may be optionally placed in or received by the ball holders 124 of the tailgate liner 104.

A variety of games may be played using the components provided by the tailgate liner 104. In one game, game play includes arranging game pieces, including cups 120 and one or more balls 134 in designated locations. For example, cups 120 may be placed in desired cup holders 110 on one or both sides of the tailgate liner 104, and play occurs by taking a ball 134 and either tossing the ball toward the cup(s) on an opposite end of the game board 108, or bouncing the ball on the flat planar bounce surface 122 in an attempt to land the ball into one of the cups on the opposite end of the game board 108. While a specific game is illustrated and described herein, one of skill in the art would understand that a variety of games may be played, a variety of cup arrangements (and cup holder arrangements) may be provided or used, and the tailgate liner adapted to play such games without departing from the overall scope of the present invention.

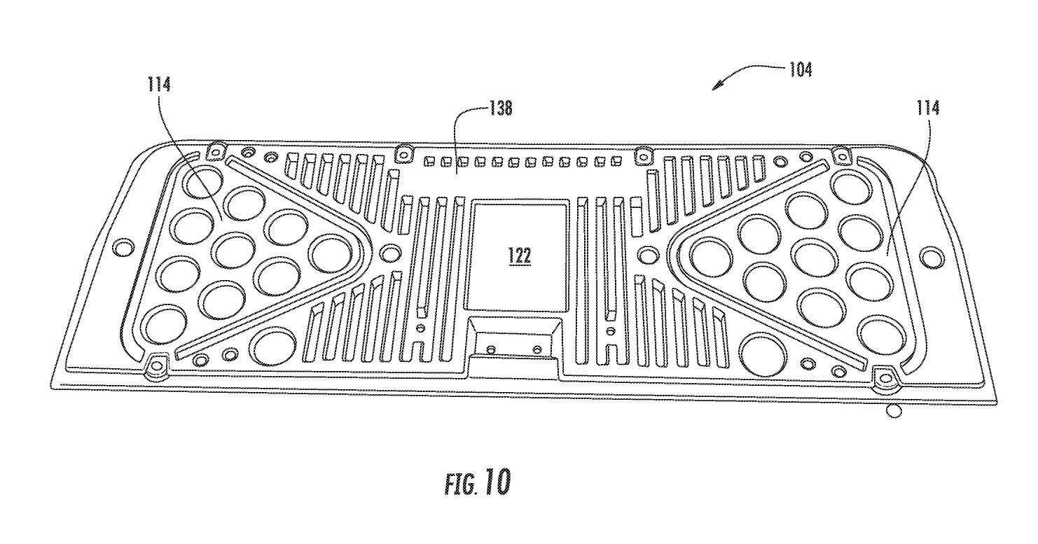

The bounce surface 122 illustrated in the various drawing figures may be fully or partially covered by a decal-type decorative material (not shown), which may variously include a manufacturer's trademark, logo or contact information, a team logo and/or trademark, and/or favorite team colors. Additionally, a manufacturer's trademark and/or website or other contact information may be formed in the tailgate liner, or alternatively fastened to the tailgate liner upper surface, in or on an identity plaque surface 138 in a prominent portion of the liner 104, as shown in FIG. 10.

The tailgate liner and game apparatus provide a simple, compact, convenient, and inexpensive tailgate liner which provides an integrated gaming apparatus for a pick-up truck tailgate. The tailgate liner provides pre-set positions for game play and positioning of pieces (e.g., cups), enabling quick, easy, and convenient set up and play. Moreover, the tailgate liner is formed of a material and size consistent with conventional plastic bed liners and still protects the finish of the vehicle, is inexpensive to manufacture, and is durable enough to withstand typical pick-up truck use, including sliding articles or packaged commodities over the tailgate liner surface when loading or unloading the truck cargo bed during normal use of the pick-up truck.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, the length or width of the structures and/or members or connectors or other elements of the system may be varied, the nature or number of adjustment positions provided between the elements may be varied (e.g. by variations in the number of engagement slots or size of the engagement slots or type of engagement). Other substitutions, modifications, changes and omissions may be made in the design, operating conditions and arrangement of the various examples of embodiments without departing from the spirit or scope of the present inventions.

This invention has been described in conjunction with the examples of embodiments outlined above. However, various alternatives, modifications, variations, improvements and/or substantial equivalents, whether known or that are or may be presently foreseen, including modifications and variations in size or shape to fit additional existing or yet to be designed popular truck tailgate structures, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

1. A tailgate liner and game apparatus comprising:
a generally rectangular panel sized and integrally formed to fit on a truck tailgate surface and substantially cover and protect an underlying surface of the truck tailgate;
wherein the panel includes a game board integrally formed therewith, the game board having game elements comprising at least one plurality of cup holders arranged in a triangular formation on the panel such that the triangular formation of cup holders is positioned near an end of the generally rectangular panel and points toward an opposite end of the panel, and a flat bounce surface provided between the at least one triangular formation and the opposite end of the panel.

2. The tailgate liner and game apparatus of claim 1, wherein the game board game elements include two pluralities of cup holders arranged in triangular formations on the panel with each of the two triangular formations respectively positioned near a one of the ends of the rectangular panel and facing the other triangular formation positioned near an opposite end of the panel in a generally mirror image relation such that the triangular formations each point toward the other, and wherein the flat bounce area game element is positioned between the two triangular formations.

3. The tailgate liner and game apparatus of claim 1, wherein a plurality of engagement apertures are defined by and through the panel, which apertures are arranged to facilitate coupling of the panel to a truck tailgate surface, the engagement apertures each being receptive to at least one fastener for coupling the panel to the truck tailgate surface and being positioned within the panel in a manner which enables such fasteners to firmly secure the panel to the referenced truck tailgate surface so as to resist or prevent movement of the panel and the game elements thereon with reference to a coupled tailgate surface.

4. The tailgate liner and game apparatus of claim 1, wherein the triangular formations of cup holders are further defined by outer recesses or ribs.

5. The tailgate liner and game apparatus of claim 1, wherein all cup holders have bases which are provided on a same flat plane, and each cup holder is of equal size and depth and spaced equidistant from adjacent cups such that rims of the cups touch each other while allowing the cups to sit flat.

6. The tailgate liner and game apparatus of claim 1, wherein at least one of the triangular formations has an additional cup holder located outside of the triangular formation and spaced such that a cup placed therein does not touch the other cups in the triangular formation.

7. The tailgate liner and game apparatus of claim 1, wherein the cup holders each have a base forming a stable surface for holding a cup.

8. The tailgate liner and game apparatus of claim 1, wherein the flat bounce surface is defined by a generally rectangular planar area.

9. The tailgate liner and game apparatus of claim 1, wherein at least one game ball holder is formed by an indent or recess in an outer facing surface of the tailgate liner generally adjacent to the at least one triangular formation.

10. The tailgate liner and game apparatus of claim 1, wherein the panel has a plurality of spaced apart ribs extending in parallel relation perpendicular to the direction of play which provide rigidity, utility, and a flat game board, the plurality of spaced apart ribs being positioned in a central portion of the panel which generally extends between the two triangular patterns and surround portions thereof as well as surrounding the flat bounce surface.

11. A tailgate liner for a pick-up truck comprising:
a rigid polymer sheet formed to a configuration corresponding to the shape of a pick-up truck tailgate and securable to the tailgate;
wherein the rigid polymer sheet is durable and protects at least a portion of the pick-up truck tailgate; and
wherein the rigid polymer sheet includes an integrally formed game surface configured to receive game pieces for game play.

12. The tailgate liner of claim 11, wherein the polymer is a high density polyethylene material.

13. The tailgate liner of claim 11, wherein the rigid polymer sheet has an embossed surface.

14. The tailgate liner of claim 11, wherein the rigid polymer sheet has a formed thickness of between about 0.04 inches and about 0.18 inches.

15. The tailgate liner of claim 11, wherein the rigid polymer sheet is a generally rectangular panel sized and shaped to fit on a pick-up truck tailgate surface and substantially cover an entire exposed surface of the pick-up truck tailgate surface.

16. The tailgate liner of claim 11, wherein the game surface has a plurality of cup holders arranged in triangular formations on the rigid polymer sheet forming two triangular formations of cup holders each facing the other in a mirror image relation such that the triangular formations point toward each other, and wherein the game surface has a flat bounce surface provided between the two triangular formations and spaced equidistant between the two triangular formations.

17. The tailgate liner of claim 11, wherein one or more engagement apertures are defined by the rigid polymer sheet which are arranged to couple the panel to a pick-up truck tailgate surface, the engagement apertures being receptive to fasteners and being positioned to firmly position and secure game elements so as to resist or prevent movement when fastened to a tailgate surface.

18. The tailgate liner of claim 11, wherein at least one recessed fastener bearing surface is formed in the panel, and wherein each such fastener bearing surface is adapted to facilitate a location for drilling or otherwise piercing an engagement aperture in the panel by a user of the tailgate liner, which aperture is receptive to a fastener for securing the liner to a truck tailgate.

19. A tailgate liner and game apparatus comprising a generally rectangular panel sized and shaped to fit on a truck tailgate surface and substantially covering the entire exposed truck tailgate surface, the panel comprising:
a game board integrated therewith, the game board having an arrangement and positioning of cup holders including a plurality of circular cup holders arranged in a triangular formation on either end of the tailgate liner to form two triangular formations of cup holders each facing the other in a mirror image relation such that the triangular formations point toward the center portion of the game board, the triangular formations of cup holders being further defined by outer recesses or ribs:
wherein the cup holders each have a generally flat planar base forming a stable surface for holding a cup and all cup holders are provided on the same flat plane, each cup holder being of equal size and depth and spaced equidistant from adjacent cups such that rims of the cups touch each other while allowing the cups to sit flat;
wherein each triangular formation has an additional cup holder located outside of the triangular formation and spaced such that a cup placed therein does not touch the other cups in the triangular formation;
a flat bounce surface defined by a generally rectangular or square flat area provided between the two triangular formations;
one or more game ball holders formed by indents or recesses in an outer facing surface of the tailgate liner;
a plurality of spaced apart ribs extending in parallel relation perpendicular to the direction of play which provide rigidity and utility, for the game board, the plurality of spaced apart ribs being positioned in a central portion of the panel which generally extends between the two triangular patterns of cup holders and surround portions thereof as well as surrounding the flat planar bounce surface;
one or more engagement apertures provided in and through the panel which are arranged to enable the panel to be securely coupled to the truck tailgate surface; and
the engagement apertures each being receptive to one or more fasteners inserted into the engagement apertures for engagement with the tailgate surface to secure the panel to the truck tailgate surface.

20. The tailgate liner and game apparatus of claim 19, wherein the generally rectangular panel is a rigid polymer sheet, and wherein the rigid polymer sheet includes the integrally formed game board.

21. The tailgate liner and game apparatus of claim 20, wherein the polymer is a high density polyethylene material.

22. The tailgate liner of claim 19, wherein the rigid polymer sheet has an embossed surface.
